(19) United States
(12) Patent Application Publication
(10) Pub. No.: US 2015/0048598 A1
(43) Pub. Date: Feb. 19, 2015

(54) Walker Device with Air Tank Holder

(71) Applicant: John Freeman, Norvolk, VA (US)

(72) Inventor: John Freeman, Norvolk, VA (US)

(21) Appl. No.: 14/459,462

(22) Filed: Aug. 14, 2014

Related U.S. Application Data
(60) Provisional application No. 61/866,800, filed on Aug. 16, 2013.

(51) Int. Cl. A61H 3/04

(52) U.S. Cl. CPC A61H 3/04; A61H 2003/046; A61H 2003/002
USPC 280/639

(57) ABSTRACT

Disclosed is a foldable walker device with an air tank holder. The purpose of the present invention is to enable individuals to easily transport an air tank while using a walker. The air tank holder includes a vertical support with upper and lower outwardly protruding rings that are used to hold an air tank in place. The upper ring is positioned at a substantial midpoint of the vertical support to maintain the air tank in an upright position. The lower ring can be positioned at the bottom of the vertical support and can have a rod extending along the diameter of the ring to support the base of the air tank. The air tank holder is affixed to a front of a walker to prevent the air tank holder from hitting the user's legs when the user is walking.

### CROSS REFERENCE TO RELATED APPLICATION

This application claims the benefit of U.S. Provisional Application No. 61/866,800 filed on Aug. 16, 2013. The above identified patent application is herein incorporated by reference in its entirety to provide continuity of disclosure.

### BACKGROUND OF THE INVENTION

1. Field of the Invention

The present invention relates to a walker with an air tank holder. More specifically, the present invention pertains to an improved foldable walker with an air tank holder affixed centrally at the front portion thereof. The air tank holder protrudes outwardly and faces away from the user so as to allow the user to walk without added hindrance.

A walker is a tool for disabled or elderly people who need additional support to maintain balance or stability while walking. When using a walker, the user walks with the walker surrounding his or her front and sides so that the user can place his or her hands on the sides of the walker where the handles are typically disposed. Generally, a walker is picked up and placed back on the ground a short distance ahead of the user. The user then walks to toward the walker and repeats the process. Some walkers comprise a plurality of wheels so that the walker can be rolled across the walking surface. With the use of wheels and glides, the user may simply push the walker as the user walks.

Because the user is required to hold the walker to move the walker while maintaining balance, it can be extremely difficult and inconvenient to carry other items while using a walker, especially when the user has limited mobility. For instance, individuals who require an air tank to breathe find great difficulty when having to carry the tank while using a walker. The air tank can be cumbersome and too heavy to carry, and when the air tank is connected a breathing tube, the tube can snag and get caught.

While some individuals receive assistance from others, it is inconvenient and impracticable to find assistance when moving from place to place. Furthermore, some individuals may desire independence so that they can move freely without seeking help. Therefore, a walker that can help individuals with limited mobility to walk while providing means to easily and conveniently transport an air tank or other similar apparatus is desired.

The present invention is a walker with a built-in air tank holder. The walker comprises a pair of frames that are connected by means of horizontal supports. The air tank holder is centrally located along the exterior of the horizontal supports at the front portion of the walker so that the air tank holder protrudes outward therefrom. In this way, the positioning of the air tank holder prevents the air tank from interfering with the user when walking. In one embodiment, the walker further comprises a seat so that the user can sit as needed while using the device. Additionally, the walker can be folded so that it may be easily stored when not in use.

2. Description of the Prior Art

Devices have been disclosed in the prior art that claim walkers with oxygen tank holders. These include devices that have been patented and published in patent application publications. Some of these devices disclose a walker with a bracket for holding an oxygen tank. Other devices disclose a wheeled oxygen tank holder. These devices, however, do not disclose a foldable walker with an air tank holder that does not detract from the user's mobility. The foregoing is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 6,672,321 to Hamilton and U.S. Pat. No. 7,726,327 to Battiston disclose a walker that is adapted to carry an oxygen tank. Hamilton discloses a strap assembly to secure the oxygen tank to the front of the walker so that the oxygen tank is facing inward toward the user. Battiston discloses a J-shaped support with an upper and a lower ring attached thereto. The upper and lower rings are aligned with each other and are separated by a space. The upper and lower rings are also biased toward the user so that the rings face inward. Each of the upper and lower rings is adapted to receive a portion of an oxygen tank therein so that the bottle is secured in an upright position.

The foregoing Battiston and Hamilton devices, however, are directed toward a walker with an oxygen tank carrier that faces inward toward the user. Such positioning of the carrier gives less room for the user to position himself or herself between the walker device and can interfere with the user's gait when walking, which is particularly problematic for users with limited mobility. The construction of the present invention eliminates the restricted mobility that is caused by the walker devices of Battiston and Hamilton. The present invention comprises an air tank holder that faces outward, or away from the user. In this way, the user can utilize the walker without hitting the air tank holder.

U.S. Pat. No. 4,251,044 to Olson discloses a foldable walker with a first and a second side frame. The first side frame comprises a ring attached thereto by means of a bracket. The ring is adapted to hold an air tank in an upright position. The second side frame comprises an IV stand with a cross member. While the device of Olson discloses a foldable walker with a built in carrier for an air tank, the device of Olson fails to disclose a vertical support with an upper and a lower ring for holding an air tank. Further, the placement of the air tank prevents the walker from evenly distributing the weight of the air tank so that the walker stays balanced. In contrast, the present invention provides an air tank holder having a vertical support with an upper and a lower ring attached thereto. The upper ring comprises a handle for grabbing the air tank holder when inserting or removing the air tank therefrom. The lower ring comprises a rod for preventing the air tank from falling through the lower ring.

U.S. Pat. No. 7,243,666 to Carroll discloses a wheeled walker with carriers for two oxygen tanks. The device comprises a walker having a support bar with a ring-shaped tank support and a cupped support. In a first embodiment, the carriers are on opposing sides of the walker. In a second embodiment, the carriers are attached to the seat at the proximate end thereof. Because the device of Carroll is designed to carry two oxygen tanks, the carriers are not located centrally to the walker. Additionally, the placement of the carriers in the second embodiment of the Carroll device obstructs the view of the user when using the walker.

Finally, U.S. Pat. No. 8,262,106 to Suszynsky discloses a wheeled oxygen tank carrier for wheelchair bound individuals. The device comprises a wheeled stand and a telescoping bar extending upward therefrom. The telescoping bar comprises an upper and a lower adjustable strap for securing an oxygen tank to the carrier. Unlike the present invention, however, the device of Suszynsky does not disclose a walker. The present invention discloses a walker for helping individuals with limited mobility to become more independent when moving from a place to place. In this way, the design and intent of the Suszynsky device differ from the present invention.

The devices disclosed in the prior art have several known drawbacks. These devices are limited in the fact that the air tank holders protrude inward and toward the user, thereby reducing the amount of room within the walker. The present invention overcomes these limitations by disclosing a walker device with an outward facing air tank holder. The placement of the air tank holder is particularly advantageous to individuals with limited mobility because the present invention allows individuals to use the walker in a conventional manner without hitting the air tank holder. It is therefore submitted that the present invention is substantially divergent in design elements from the prior art, and consequently it is clear that there is a need in the art for an improvement to walkers with oxygen tank holders. In this regard, the instant invention substantially fulfills these needs.

### SUMMARY OF THE INVENTION

In view of the foregoing disadvantages inherent in the known types of walkers with oxygen tank holders now present in the prior art, the present invention provides a new and improved walker device with an air tank holder wherein the same can be utilized for conveniently transporting an air tank when using a walker.

It is therefore an object of the invention to provide a new and improved walker device with an air tank holder that has all of the advantages of the prior art and none of the disadvantages.

Another object of the present invention is to provide a walker device with an air tank holder wherein the air tank holder comprises a vertical support, an upper ring, and a lower ring with a means to prevent an air tank from falling therethrough.

Yet another object of the present invention is to provide a new and improved walker device with an air tank holder wherein the air tank holder protrudes outward and away from the user to allow the user to use the walker device in a conventional manner without hitting the air tank holder.

Still yet another object of the present invention is to provide a new and improved walker device with an air tank holder wherein the walker device is foldable.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein the numeral annotations are provided throughout.

FIG. 1 shows a perspective view of the present invention.

FIG. 2 shows a perspective view of the present invention in a folded configuration.

FIG. 3 shows a view of the present invention in use to hold an air tank.

### DETAILED DESCRIPTION OF THE INVENTION

References are made herein to the attached drawings. Like reference numerals are used throughout the drawings to depict like or similar elements of the walker device with an air tank holder. For the purposes of presenting a brief and clear description of the present invention, the preferred embodiment will be discussed as used to conveniently transport an air tank when using a walker. The figures are intended for representative purposes only and should not be considered to be limiting in any respect.

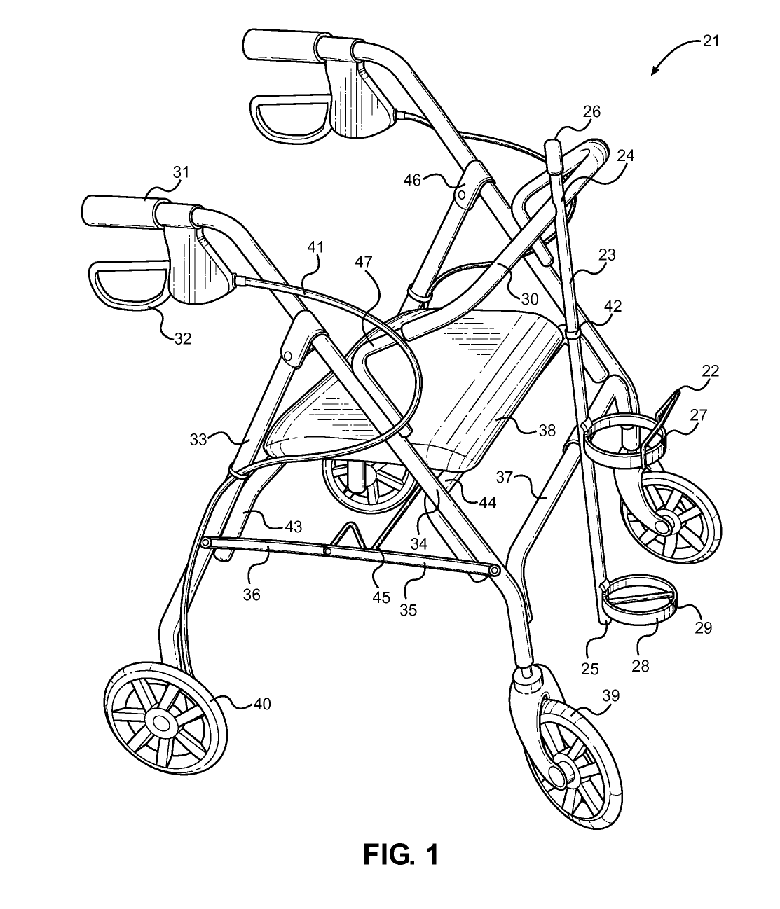

Referring now to FIG. 1, there is shown a perspective view of the present invention. The present invention comprises a walker 21 having a pair of side frames that are connected via a set of horizontal bars, front and rear wheels with a braking mechanism, an oxygen tank holder, and a pivotally attached seat. In the illustrated embodiment, the side frames comprise an inverted Y-shape. However, the side frames may be of various shapes and constructions in accordance with the present invention.

In the illustrated embodiment, the inverted Y-shaped frames are approximately waist high and are spaced apart so that the distance between the two frames is slightly wider than the user. Additionally, the frames are sufficiently deep so that users can keep their hands by their side when walking with the device. The inverted Y-shaped frame comprises a first section 33 and a second section 34, each of the first section 33 and the second section 34 having an upper end and a lower end. It is contemplated that the length of the second section 34 is greater than the length of the first section 33. The lower end of the first section 33 is attached to a rear wheel 40. The lower end of the second section 34 is attached to a front wheel 39.

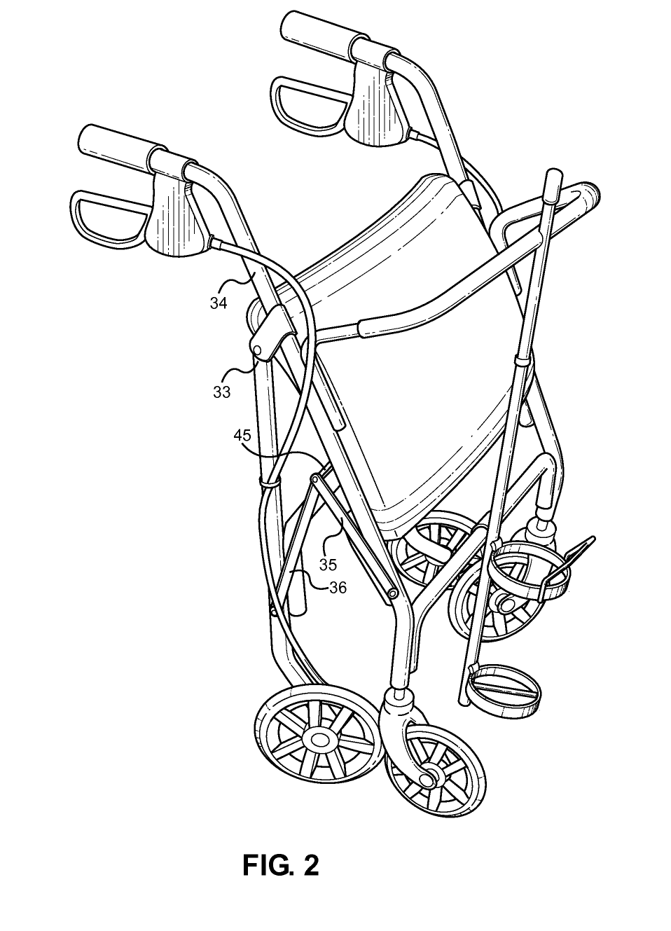

The upper end of the first section 33 is hingedly attached near the upper end of the second section 34 by means of a bracket 46. As such, the upper end of the second section 34 extends beyond the upper end of the first section 33. The first section 33 and the second section 34 are also joined near the lower end by means of a brace having a first segment 35 and a second segment 36. The first 35 and second segment 36 are overlapped and pivotally connected by a fastener so that the two segments can pivot to fully extend into a linear configuration or fold against each other. In this way, the walker of the present invention can fold, as illustrated in FIG. 2. The brace in each of the inverted Y-shaped frames may be connected together by means of a horizontal support rod 45. The horizontal support rod 45 stabilizes the braces by preventing each of the brace from flexing inward and outward.

The upper end of the second section 34 comprises a handle thereon. The handle may include gripping portion 31 that is composed of padded and high friction material. The gripping portion 31 comprises a cylindrical shape with a hollow middle that is adapted to receive the ends of the handle therein. The handle also comprises a brake handle 32 that is connected to a brake mechanism and a brake guide line 41. In the illustrated embodiment, the brake guide line 41 is connected to the rear wheels 40. However, it is understood that the brake guide line 41 may be connected to the front wheels, depending upon embodiment. In this way, the walker 21 is prevented from moving forward or backward when the brake handle 32 is actuated and the brakes are applied to the rear wheels 40.

The inverted Y-shaped frames are connected at the front by means of an upper horizontal bar 47 and a lower horizontal bar 37. The terminal end of the upper horizontal bar 47 is affixed near the midpoint of the second section 34, and the terminal end of the lower horizontal bar 37 is affixed near the lower end of the second section 34. The upper horizontal bar 47 protrudes outward and comprises a padded portion 30 that extend between the terminal ends of the horizontal bar 47. Each of the upper 47 and lower horizontal bars 37 is perpendicular relative to the inverted Y-shaped frames. In this way, the inverted Y-shaped frames are parallel to each other.

The inverted Y-shaped frames also comprise a seat 38 that is pivotally attached to a front seat support frame 44 and a rear seat support frame 43. In the illustrated embodiment, the seat 38 is substantially rectangular and comprises cushioning so as to provide comfortable seating when needed. A terminal end of the front seat support frame 44 is affixed to substantial midpoint of the second section 34. Similarly, a terminal end of the rear seat support frame 43 is affixed to substantial midpoint of the first section 33. When viewed from the side, the front 44 and rear 43 seat support frames are aligned horizontally. In this way, the seat 38 is level and parallel to the ground.

The air tank holder is centrally located at the front of the walker 21. The air tank holder comprises a vertical support 23, an upper ring 27, and a lower ring 28. The air tank holder is typically formed of a metal such as aluminum. The vertical support 23 is permanently attached to the walker 21 at a substantial midpoint of each of the upper horizontal bar 47 and the lower horizontal bar 37 by means of fasteners such as a bolts. Alternatively, the vertical support 23 may be connected to a bracket that is welded to midpoint of the upper horizontal bar 47 and lower horizontal bar 37. Additionally, in some embodiments, the vertical support 23 may also be connected to a strap 42 that is secured to the front seat support frame 44. When viewed from the side, the vertical support 23 is secured in a substantially upright position.

The vertical support 23 is preferably an elongated tube comprising an upper end 24 and a lower end 25. The upper end 24 of the vertical support comprises a rubber tip 26 to cover the sharp edges thereon. The lower end 25 of the vertical support 23 comprises a lower ring 28 attached thereto by means of a fastener, such as a bolt. An exterior surface of the lower ring is attached to the vertical support such that the vertical support is not positioned within the interior area of the lower ring. The lower ring 28 comprises a rod 29 that spans the diameter or the interior of the ring 28. The rod 29 may be affixed in place via fasteners or it may be welded to the ring 28. The rod 29 is adapted to prevent an air tank from falling through the lower ring 28 when placed therein. The vertical support 23 further comprises an upper ring 27 attached to its substantial midpoint, or near the lower horizontal bar 37. The upper ring 27 comprises a handle 22 attached thereto. The diameter of the upper ring 27 may be substantially equal to the diameter of the lower ring 28. Additionally, the upper 27 and lower rings 28 may be directly aligned so as to receive the air tank therein and to maintain the tank in a vertical orientation.

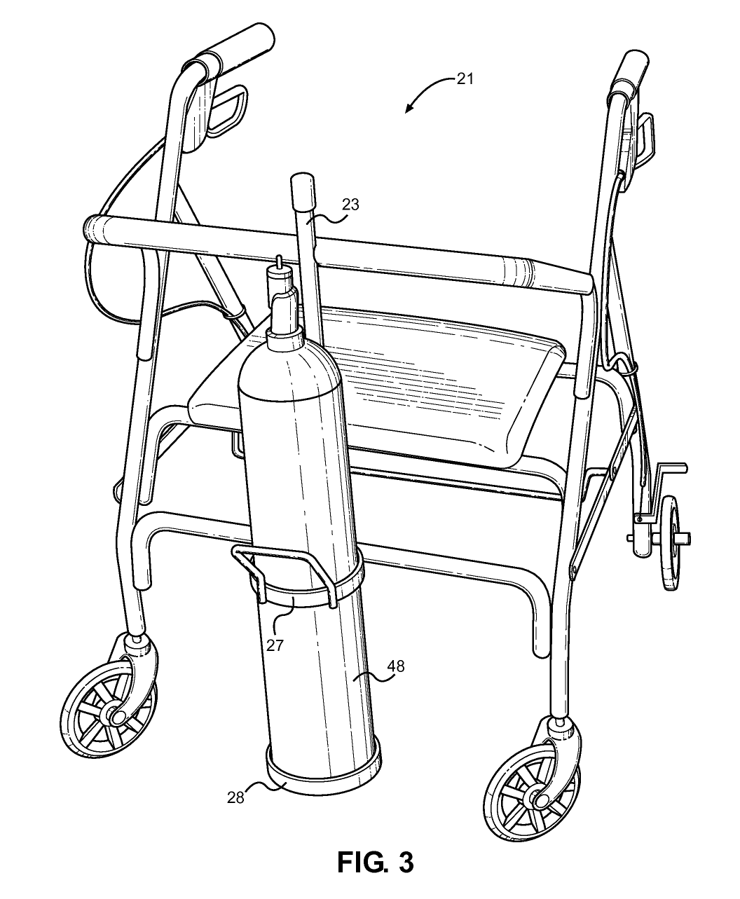

Referring now to FIG. 3, there is shown view of the present walker 21 in use to hold an air tank 48. The air tank 48 is inserted from the top so that the bottom portion of the air tank 48 is inserted through the upper ring 27 and rests on the lower ring 28. When in place, the upper ring 27 wraps around the middle portion of the air tank 48 and the lower ring 28 wraps around the bottom portion of the air tank 48. Because the vertical support 23 is in an upright position, the air tank 48 is also secured in an upright position. Each of the upper 27 and lower rings 28 is constructed so that they fit around the exterior surface of the air tank.

The placement of the air tank holder of the present invention is advantageous in that it does not interfere with the use of the walker 21. For instance, the user is able to utilize the seat because the upper 27 and lower rings 28 protrude outward, and away from the user on the exterior portion of the walker 21. Additionally, the disposition of the air tank holder prevents the user from hitting his or her knees or seeing ahead of the user when walking. In this way, the present invention does not interfere with the user's ability to walk while using the walker. Furthermore, it is contemplated that the present invention may be constructed to accommodate pediatric and bariatric sizes.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above descriptions then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A walker device, comprising:
a pair of frames having a first section that is hingedly attached to a second section;
each of said first section and said second section having an upper end and a lower end;
said upper end of said second section having a handle;
said lower end of said first section having a rear wheel;
said lower end of said second section having a front wheel;
an upper horizontal bar;
a lower horizontal bar;
each of said upper horizontal bar and said lower horizontal bar attached to said second section and extending between said pair of frames;
an air tank holder having a vertical support, an upper ring, and a lower ring having a rod that spans of the interior of said lower ring;
said vertical support having an upper end and a lower end;
wherein said lower ring is attached to said lower end and said upper ring is attached to said vertical support at a midpoint thereof;
said vertical support attached to said upper horizontal bar and said lower horizontal bar.

2. The walker device of claim 1, wherein said handle further comprises a brake handle that is connected to a brake mechanism and a brake guide line;
wherein said brake guide line is connected to said rear wheel.

3. The walker device of claim 1, wherein said handle further comprises a gripping portion.

4. The walker device of claim 1, further comprising a brace having a first segment and a second segment;
each of said first segment and said second segment having a first end and a second end;
said first end of said first segment attached to said second section;
said first end of said second segment attached to said first section;
said second end of said first segment and said second end of said second segment overlapping and pivotally connected by means of a fastener.

5. The walker device of claim 4, further comprising a horizontal support rod attached to said brace;
said horizontal support rod extending between said pair of frames.

6. The walker device of claim 1, further comprising:
a front seat support frame attached to said second section;
a rear seat support frame attached to said first section;
each of said front seat support frame and said rear seat support frame extending between said pair of frames;
a seat pivotably attached to said front seat support frame and said rear seat support frame.

7. The walker device of claim 1, wherein said upper ring comprises a handle.

8. The walker device of claim 1, wherein said upper horizontal bar comprises a padded portion that extend between terminal ends of said upper horizontal bar.

9. The walker device of claim 1, wherein said pair of frames is inverted Y-shaped.

10. The walker device of claim 1, wherein an edge of said lower ring is connected to said vertical support and an edge of said upper ring is connected to said vertical support.

11. The walker device of claim 1, wherein said upper ring and said lower ring are vertically aligned.

12. The walker device of claim 1, wherein said upper ring includes a handle thereon.

13. The walker device of claim 1, wherein each of said upper ring and said lower ring is substantially circular.
